(19) United States
(12) Patent Application Publication
(10) Pub. No.: US 2003/0078775 A1
(43) Pub. Date: Apr. 24, 2003

(54) System for wireless delivery of content and applications

(76) Inventors: Scott Plude, Mountain View, CA (US); Owen Lynn, Mountain View, CA (US); Rena Yamamoto, Berkeley, CA (US); Yong Tian, Sunnyvale, CA (US); Dan Kolkowitz, Los Altos, CA (US); Daniel Zucker, Palo Alto, CA (US); Phil Straw, El Granada, CA (US); Eric Lunsford, San Carlos, CA (US); Mahesh Subramanian, Foster City, CA (US); Monali Jain, Fremont, CA (US); Hayk Khachikyan, Sacramento, CA (US)

Correspondence Address: Robert E. Krebs, BURNS, DOANE, SWECKER & MATHIS, L.L.P., P.O. Box 1404, Alexandria, VA, 22313-1404, US

(21) Appl. No.: 10/117,341

(22) Filed: Apr. 8, 2002

Related U.S. Application Data
(60) Provisional application No. 60/345,880, filed on Oct. 22, 2001.

(51) Int. Cl. G10L 15/26

(52) U.S. Cl. 704/235

(57) ABSTRACT

Wireless, hands-free Internet access is facilitated using a mobile unit including a text-to-speech converter and a speech recognition unit. A processing unit operating in conjunction with a cellular telephone and a personal information management unit runs voice-clipping applications whose resources include markup language based information exchanged wirelessly, such that the processing unit interacts with a content server connected to the Internet. Hands-free access to the Internet is thereby gained.

### CROSS-REFERENCE TO RELATED APPLICATIONS

The present application claims priority to U.S. Provisional Patent Application entitled “System And Method For Wireless Exchange Of Voice Information Between A User And A Network” filed on Oct. 22, 2001, and having a Serial No. 60/345,880.

### BACKGROUND OF THE INVENTION

1. Field of the Invention

The invention relates to wireless delivery of network based information.

2. Description of Related Art

The uses and advantages of the Internet are well known and have become an integral part of modern life. Access to the Internet, however, has been rather restricted in terms of mobility, and generally requires a stationary personal computer on the one hand, or a movable laptop. However, while use of a laptop in conjunction with a wireless modem or cellular telephone to access the Internet is known, such access requires extensive manual input from the user. Navigation through the Internet to obtain useful information requires input from at least one hand of the user, and preferably both hands. It also requires visual attention, and input received from the browser needs to be visually displayed for assessment by the user. These and other restrictions, require that access to the Internet be a dedicated, undistracted task, and have precluded the performance of the other tasks during access. One particularly difficult task to perform while accessing the Internet, therefore, is operating a motor vehicle.

Voice-based interactions with a computer, and voice-based access to the Internet have been proposed as solutions to the problem of providing access to the Internet while driving. However, current methodologies for effecting this have been very limited, and have not met with appreciable success. Markup language use, for example that of voiceXML, has proven to be unreliable and cumbersome for exchange of information wirelessly over the Internet, because of the computational burdens imposed by conventional speech recognition and conversion systems, and their inefficient interaction with voice XML.

### BRIEF SUMMARY OF THE INVENTION

In accordance with the invention, a mobile unit is provided, which includes an automatic speech recognition unit, a text-to-speech unit, and a voice browser. The voice browser interacts with the automatic speech recognition unit and the text-to-speech unit to allow voice-based interactions with a user, and is at least partially controlled by markup language-based pages received from an external network across a cellular connection. At least some of the markup language based pages include text data for the text-to-speech unit to convert to speech, information affecting which utterances of a user are recognized by the automatic speech recognition unit, and flow control information.

Further in accordance with the invention, a mobile unit is provided which comprises a personal information management unit, an automatic speech recognition unit, a text-to-speech unit, and a voice browser. The voice browser interacts with the automatic speech recognition unit and the text-to-speech unit to allow voice-based interactions with a user, the voice-based interactions being at least partially controlled by markup language based information received from an external network across a wireless connection, the voice browser further interacting with the personal information management unit to update personal information in the personal information management unit as a result of voice browsing operations and/or to use personal information in the personal information management unit to effect the voice browsing operations.

Further in accordance with the invention, there is provided a mobile unit comprising a global positioning system unit, an automatic speech recognition unit, a text-to-speech unit, and a voice browser, wherein the voice browser interacts with the automatic speech recognition unit and the text-to-speech unit to allow voice-based interactions with a user, the voice-based interactions being at least partially controlled by markup language based information received from an external network across a cellular connection. The voice browser interacts with the a global positioning system to effect voice browsing operations.

In accordance with the invention, a mobile unit is provided which includes an automatic speech recognition unit, a text-to-speech unit, and a voice browser. The voice browser interacts with the automatic speech recognition unit and the text-to-speech unit to allow voice-based interactions with a user, the voice-based interactions being at least partially controlled by markup language based pages received from an external network across a wireless connection, the voice browser having a native mode in which no cellular connection is required and a web connection mode in which markup language based information is downloaded using a wireless connection.

Further in accordance with the invention, a mobile unit is provided which comprises an automatic speech recognition unit, a text-to-speech unit and a voice browser, the voice browser interacting with the automatic speech recognition unit and the text-to-speech unit to allow voice-based interactions with a user, the voice-based interactions being at least partially controlled by markup language based information received from an external network across a wireless connection, the voice browser having a telephone phone call mode in which a cellular connection to telephone-based voice mail or E-mail system is facilitated by the voice browser and a web connection mode in which markup language based information is downloaded using a cellular connection.

Further in accordance with the invention, there is provided a mobile unit which includes an automatic speech recognition unit, a text-to-speech unit, and a voice browser, the voice browser interacting with the automatic speech recognition unit and the text-to-speech unit to allow voice-based interactions with a user, the voice-based interactions being at least partially controlled by markup language based pages received from an external network across a wireless connection, the markup language based pages including tags, wherein at least some of the markup language based pages are such that tag codes are used instead of at least some of markup language tags, the tag codes being shorter than the at least some of the markup language tags, the voice browser interpreting the tag codes as if they were the corresponding markup language tag.

### BRIEF DESCRIPTION OF THE SEVERAL VIEWS OF THE DRAWING(S)

Many advantages of the present invention will be apparent to those skilled in the art with a reading of this specification in conjunction with the attached drawings, wherein like reference numerals are applied to like elements.

FIG. 1 is a schematic diagram of an exemplary system for wireless delivery of content and applications in accordance with the invention.

FIG. 2 is a schematic diagram of a mobile unit with associated components and devices in accordance with the invention.

### DETAILED DESCRIPTION OF THE INVENTION

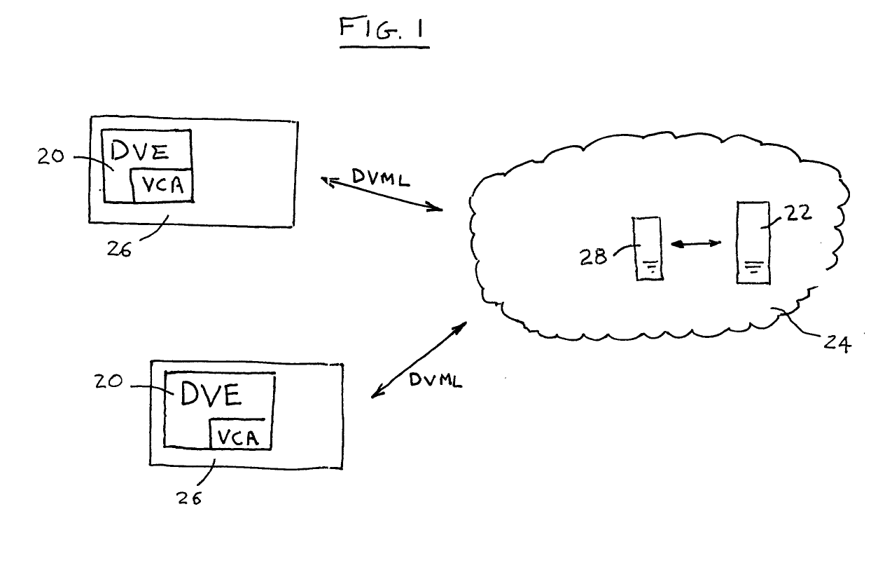

FIG. 1 shows a schematic diagram of an exemplary system for wireless delivery of content and applications in accordance with the invention. The system operates under a client-server model. A distributed voice engine (DVE) operating as a browser in one or more client computing or processing devices 20 is in communication with one or more content (web) servers 22 via a network 24, for example the Internet. The client processing device 20 is preferably part of a mobile unit 26 associated with a vehicle, for example a car driven by a user. The mobile unit 26 can include one or more devices such as a cellular telephone, personal digital assistant (PDA), or a laptop, or a combination of such devices or their equivalents, configured to wirelessly access the network 24. The DVE in the processing device 20 is preferably a software program configured to run voice clipping applications (VCA) which facilitate information exchange between the user at processing device 20 and the content server 22. The information thus exchanged is packaged in markup language format, herein referred to as distributed voice markup language, or DVML, and may be compressed to facilitate transfer. The markup language, an example of which is attached hereto as Appendix A, contains tags, which are converted to codes in execution. Alternatively, tag codes, which are shorter than tags, can be used, and are interpreted by the browser as if they were the corresponding codes. The VCA comprises a set of files or other information, transferred to the DVE in DVML format from the content server 22, and interacting with the DVE at the control of the user. The files, and specifically, the information contained therein, is modified in accordance with input from the user, or in accordance with other applications, such as those involving location information derived through GPS (Global Positioning System) as described below. Some funtions of the information include providing data for conversion to speech, affecting which utterances of a user are recognized, and providing system flow control, as discussed below.

Preferably included in the system are one or more proxy servers 28, herein referred to as a voice clipping proxy server, or VCPS. DVML pages are packaged by proxy server 28 for transmission to voice clipping application (VCA) running at the processing device 20. The transmission is effected bidirectionally, such that DVML pages, files and information are also sent from the mobile unit 26 to the content server 22, via proxy server 28. Thus proxy server 28 operates more generally as a common gateway between the voice clipping applications (VCA) and the content server 22, and is responsible for, inter alia, validating the DVML information, tokenizing the content, logging transactions, compressing information, and managing client interactions.

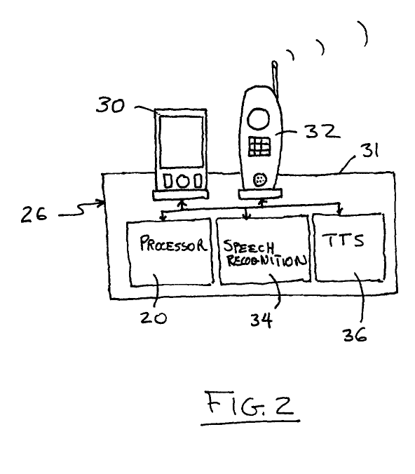

In the preferred application, the mobile unit 26 running processing device 20 includes a personal digital assistant (PDA) 30 having a personal information management routine with associated files and information, and further includes a cellular telephone 32, as shown in FIG. 2. PDA 30 and cellular telephone 32 are removably mated into housing 31 of mobile unit 26, which housing also contains processing device 20. The plug-in connection insures proper wire connection between PDA 30, cellular telephone 32, and the various components of mobile unit 26. Communication between these devices and components can alternatively be effected wirelessly, using commercial devices such as those available from Bluetooth™ (not shown). Moreover, while the processing device 20 is described as being in separate mobile unit 26, it is also contemplated that processing device 20 can be implemented within PDA 30 or telephone 32, or all three devices can be combined in a single mobile component. Cellular telephone 32 is relied upon to establish a wireless connection with an Internet service provider, thereby providing wireless access to the Internet in a conventional manner. It is also contemplated that the function of cellular telephone 32 can be implemented by mobile unit 26 using a cellular telephone transciever.

Mobile unit 26 also includes a speech recognition device 34 and a text-to-speech (TTS) conversion device 36, both of which are configured to interact with the distributed voice engine (VCE), which is effectively configured as a voice browser receiving voice commands from the user via speech recognition device 34 and providing audible/speech information to the user via TTS conversion device 36. Speech recognition device 34 and TTS conversion device 36 can be any commercially available devices, for example the LNH 1600™ speech recognition engine, and/or they can be implemented, at least partially, in software by processing device 20, or by cellular telephone 32. Speech recognition device 34 and TTS conversion device 36 respond to the markup language information exchanged between the VCE and content servers 22.

Speech recognition device 34 operates efficiently by being configured to respond to prescribed sets of grammars or pointers to grammars, which may be pre-cached by proxy server 28 and then loaded during operation, or which may be pre-stored at the DVE. The sets of grammars affect which utterances are recognized by speech recognition device 34. The sets of grammars can be either context sensitive, for example those pertaining to a particular application loaded in DVML format from the Internet, as external files of a VCA package, or those pertaining to client side applications such as an address book stored in PDA 30, or they can be global grammars which pertain to all applications run by the DVE. Different applications can have different sets of grammars or pointers to grammars associated therewith, and these sets can be pre-cached and loaded up front into the DVE when a particular VCA application is downloaded. As an example, the user's home page and preferences associated therewith, or a weather or news page, can each have a set of grammars associated therewith, and when the home page or weather page or news page are downloaded into mobile unit 26, the associated grammars file is downloaded as well.

In accordance with one application, geographically specific information can be provided to the user based on a GPS device 38 included with mobile unit 26. A, tag contained in a DVML page associated with the application—for example “<GPS ALERT>”—prompts the DVE, in conjunction with GPS device 38, to continuously monitor the geographical location of the mobile unit 26 and to determine when the geographical location meets specific conditions. When these conditions are met, for example when a particular region, identified by predetermined GPS coordinates, is reached, the DVE is prompted to respond in a suitable manner. One response can be returning an indication to the proxy server 28, via the DVML page, such that a second DVML application, for example one associated with an advertisement, is then downloaded for playback to the user. Such an advertisement is preferably relevant to the location of the mobile user—for example informing the user of the proximity of a particular commercial establishment to the user's current location.

It is also contemplated that a download of text data can be implemented, such that a promotional coupon can be downloaded into mobile unit 26 for subsequent retrieval. The download of text data for subsequent retrieval does not necessarily need to accompany a GPS application, but can be performed in accordance with other applications, such as those involving “surfing” the Internet. Downloaded information can be used to augment or update existing databases, such as the address book in PDA 30, or they can be stored in a “memopad” type application and viewed later.

The invention also implements various telephony applications, wherein the DVE facilitates interactions between the user and the cellular telephone 32. In this manner, the user can utilize the DVE to initiate telephone calls and perform dialing functions, for example to access the user's voice mail stored by a telephone service, such as the cellular telephone service, or to perform other common telephone functions, such as conduct a telephone conversation with another user. The user, by an appropriate command, can recall a particular telephony application, with the associated DVML pages, and attendant grammars list, being executed by the DVE. The DVE then prompts the user for commands, based on a text-to-speech translation run by the DVE, which may result in a query to the user, such as “What number would you like to dial?” The user then verbally provides the number, and the DVE proceeds to first take the phone off hook, then for example, generate the DTMF (dual-tone modulation frequency) signals corresponding to the numbers spoken by the user. Alternatively, the user can respond “Voice mail,” in which case the DVE performs an automatic call to the user's voice mail service, based on associated DVML pages which may either be pre-stored in the mobile unit 26, or downloaded by the DVE when needed. As part of the voice mail application, the user can then navigate through the voice mail system by speaking to the mobile unit, and the user's spoken commands, such as selection of mailbox, playing, saving, or deleting messages, and so forth, are translated into DTMF signals recognized by the voice mail system. The signals may be voice mail service-specific, and may be pre-programmed into the DVE by the user based on the user preference, or may be downloaded during operation.

Another telephony application involves calling a contact from the user's contacts list, which may be stored in PDA 30 or cellular telephone 32. The tags associated with a DVML page for calling the contact provide the grammar for recognizing the various contacts in the list, and when one of these is selected by the user, the telephone number of the contact is automatically dialed, with the DVE generating the appropriate DTMF signals which implement the dialing function. It will be appreciated that a host of telephony functions can be performed in this manner.

While DVML can use Java™ script as part of its content, it is preferred that Java™ script is not used, and instead, proprietary tags are used in accordance with the attached appendix.

The invention contemplates three general types of applications. The first is a pure content server type application, in which the DVE interacts with a remote content server 22 to provide information such as weather reports, traffic directions, news information, and so forth. The second is a hybrid type application, in which some data is derived from a remote server, while other data is acquired from a local source, such as an address book. Such use would preferably involve validation procedures before access to the user's data is gained, to prevent uninvited use of personal information, such that contained in the address book. E-mail and voice mail fall into this second type of application. The third type is purely local, and involves the updating and manipulation and use of such information as a “to do” list, a calendar, memopad, telephone directory, address book, and other information related to the personal information manager. Such updating and manipulation and use may not require a cellular connection at all, and is referred to as operation in a native mode. Flow control between these and other applications, at any possible layer, is effected based on the markup language resident in the DVE and/or associated with the particular application.

The above are exemplary modes of carrying out the invention and are not intended to be limiting. It will be apparent to those of ordinary skill in the art that modifications thereto can be made without departure from the spirit and scope of the invention as set forth in the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A mobile unit comprising:
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based pages received from an external network across a cellular connection, at least some of the markup language based pages including text data for the text-to-speech unit to convert to speech, information affecting which utterances are recognized by the automatic speech recognition unit, and flow control information.

2. The unit of claim 1, wherein the information affecting which utterances are recognized by the automatic speech recognition unit are grammars.

3. The unit of claim 1, wherein the information affecting which utterances are recognized by the automatic speech recognition unit are pointers to grammars.

4. The unit of claim 1, further including a computing device implementing at least portions of the automatic voice recognition unit, the text to speech unit and the voice browser in software.

5. The unit of claim 4, wherein the computing device is a personal digital assistant (PDA).

6. The unit of claim 1, wherein the mobile unit includes a cellular telephone.

7. The unit of claim 6, wherein the cellular telephone interacts with the computing device through wireless communications.

8. The unit of claim 6, wherein the voice browser is capable of initiating telephone calls.

9. The unit of claim 1, wherein the mobile unit is a cellular telephone adapted to implement at least a portion of one or more of the automatic voice recognition device, the text-to-speech device, and the voice browser.

10. The unit of claim 1, wherein the voice based interactions are associated with different applications, each application using a root page and associated application pages.

11. The unit of claim 10, wherein the markup language based information affects flow control between the different applications and/or within at least some said different applications.

12. The unit of claim 1, wherein the mobile unit includes a cellular transceiver.

13. The unit of claim 1, wherein the markup language based information is compressed.

14. The unit of claim 1, wherein the markup language based information contains tags which are converted to codes.

15. The unit of claim 1, wherein the markup language based information is stored at web servers connected to the external network.

16. The unit of claim 13, further comprising a proxy server adapted to compress the markup language information.

17. The unit of claim 1, wherein the proxy server converts tags in the markup language information to codes.

18. The unit of claim 1, further comprising a personal information manager, the voice browser interacting with the personal information manager to update personal information in the personal information manager as a result of voice browsing operations, or to use personal information in the personal information manager to effect voice browsing operations.

19. The unit of claim 1, further comprising a GPS device.

20. The unit of claim 1, wherein the voice browser operates in accordance with programming code to establish a connection for accessing a telephone-based voice mail system.

21. The unit of claim 1, wherein the voice browser operates in accordance with programming code to establish a connection for accessing an e-mail system.

22. The unit of claim 1, wherein the voice browser is configured to operate in a native mode in which no cellular connection is required.

23. The unit of claim 1, wherein at least some of the markup language based information includes tags and some of the markup language based information includes tag codes which are shorter than the at least some of the markup language tags, the voice browser interpreting the tag codes as if they were the corresponding markup language tags.

24. A mobile unit comprising:
a personal information management unit;
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based information received from an external network across a wireless connection, the voice browser further interacting with the personal information management unit to update personal information in the personal information management unit as a result of voice browsing operations and/or to use personal information in the personal information management unit to effect the voice browsing operations.

25. The mobile unit of claim 24, wherein the personal information management unit includes calender information.

26. The mobile unit of claim 25, wherein the calendar information is accessed by the voice browser.

27. The mobile unit of claim 24, wherein the personal information management unit includes address book information.

28. The mobile unit of claim 27, wherein the address book information is accessed by the voice browser.

29. The mobile unit of claim 24, wherein the personal information management unit includes telephone number directory information.

30. The mobile unit of claim 29, wherein the telephone number directory information is accessed by the voice browser.

31. The mobile unit of claim 30, the voice browser making telephone calls based on accessed telephone number directory information.

32. The mobile unit of claim 24, wherein interactions between the browser and the personal information management unit are subject to verbal authorization by a user.

33. The mobile unit of claim 24, wherein at least some of the markup language based information includes text data for the text-to-speech unit to convert to speech, information affecting which utterances are recognized by the automatic speech recognition unit, and flow control information.

34. The mobile unit of claim 24, further including a computing device implementing at least portions of the automatic voice recognition unit, the text to speech unit and the voice browser in software.

35. The mobile unit of claim 34, wherein the computing device implements at least portions of the personal information management unit in software.

36. The mobile unit of claim 34, wherein the computing device is a personal digital assistant (PDA).

37. The mobile unit of claim 24, further including a cellular telephone.

38. The mobile unit of claim 34, further including a cellular telephone adapted to interact with the computing device through wireless communications.

39. The mobile unit of claim 37, wherein the wireless communications is based on a Bluetooth standard.

40. The mobile unit of claim 24, wherein the voice browser is able to initiate telephone calls.

41. The mobile unit of claim 24, wherein the voice-based interactions are associated with different applications, each application using a root page and associated application pages.

42. The mobile unit of claim 40, wherein the markup language based information affects flow control between the different applications and/or within at least some said different applications.

43. The mobile unit of claim 24, wherein the markup language based information is compressed.

44. The mobile unit of claim 24, wherein the markup language based information contains tags which are converted to codes.

45. The mobile unit of claim 24, wherein the markup language based information is stored at web servers connected to the external network.

46. The mobile unit of claim 44, further comprising a proxy server adapted to compress the markup language information.

47. The mobile unit of claim 45, wherein the proxy server converts tags in the markup language information to codes.

48. The mobile unit of claim 44, further comprising a GPS (global positioning system) device interacting with the web servers connected to the external network.

49. a mobile unit comprising:
a global positioning system unit;
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based information received from an external network across a cellular connection, the voice browser interacting with the a global positioning system to effect voice browsing operations.

50. The mobile unit of claim 48, wherein the voice-based interactions include different interactions based on global positioning system unit data.

51. The mobile unit of claim 49, wherein the global positioning system unit data is used to control the presentation of driving instructions downloaded over a wireless network.

52. The mobile unit of claim 49, wherein the global positioning system unit data effects control flow through at least some markup language based pages.

53. The mobile unit of claim 49, wherein the global positioning system unit data effects presentation of advertisements

54. A mobile unit comprising:
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based pages received from an external network across a wireless connection, the voice browser having a native mode in which no cellular connection is required and a web connection mode in which markup language based information is downloaded using a wireless connection.

55. The mobile unit of claim 53, the voice browser further having a telephone call mode in which a cellular connection is made to a telephone-based voice mail or E-mail system.

56. The mobile unit of claim 53, wherein the native mode uses markup language based information stored at the mobile unit.

57. The mobile unit of claim 53, wherein the native mode interacts with a personal information management unit associated with the mobile unit.

58. A mobile unit comprising:
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based information received from an external network across a wireless connection, the voice browser having a telephone phone call mode in which a cellular connection to telephone-based voice mail or E-mail system is facilitated by the voice browser and a web connection mode in which markup language based information is downloaded using a cellular connection.

59. The mobile unit of claim 57, wherein the voice browser can initiate and control telephone calls across a cellular network.

60. The mobile unit of claim 57, wherein the voice browser is adapted to instruct a cellular phone to send DTMS signals.

61. The mobile unit of claim 57, wherein the voice browser in the telephone call mode uses at least one stored markup language based page to operate.

62. The mobile unit of claim 57, wherein the voice browser is adapted to operate in a native mode in which no cellular connection is required.

63. The mobile unit of claim 61, wherein the native mode uses markup language based information stored at the mobile unit.

64. A mobile unit comprising:
an automatic speech recognition unit;
a text-to-speech unit; and
a voice browser, the voice browser interacting with the automatic speech recognition unit and the text-to-speech unit to allow voice-based interactions with a user, the voice-based interactions being at least partially controlled by markup language based pages received from an external network across a wireless connection, the markup language based pages including tags, wherein at least some of the markup language based pages are such that tag codes are used instead of at least some of markup language tags, the tag codes being shorter than the at least some of the markup language tags, the voice browser interpreting the tag codes as if they were the corresponding markup language tag.

65. The mobile unit of claim 63, further including a proxy server adapted to convert markup language pages with markup language tags to pages with tag codes.
